(19) United States
(12) Patent Application Publication
(10) Pub. No.: US 2002/0026335 A1
(43) Pub. Date: Feb. 28, 2002

(54) Data security insurance system

(76) Inventor: Tadashi Honda, Kanagawa-ken (JP)

Correspondence Address: YOUNG & THOMPSON, 745 SOUTH 23RD STREET 2ND FLOOR, ARLINGTON, VA, 22202

(21) Appl. No.: 09/906,131

(22) Filed: Jul. 17, 2001

(30) Foreign Application Priority Data
Jul. 21, 2000 (JP) 2000-219910

(51) Int. Cl. G06F 17/60

(52) U.S. Cl. 705/4

(57) ABSTRACT

A data security insurance system stores data in a server through a network of Internet, etc., transmits the data as necessary, reconstructs the data in a short time in case of the destruction of the data, and guarantees data security. When a client 4 contracts insurance of data security through a management server of an insurance company, the data is transmitted from the terminal device of the client 4 to a backup center 2 through Internet, and the data is stored for backup. With the configuration, the data of the client can be reconstructed soon even if the data is lost by the invasion of a virus or the destruction of a hard disk, etc.

### TECHNICAL FIELD

The present invention relates to a data security insurance system for securing data by transmitting the data to be secured to a server through a network such as Internet, etc. and storing the data therein.

### BACKGROUND ART

Recently, computers are used in various fields independently and through a LAN such as Ethernet, etc. In such computer systems, a database is indispensable, and an enormous amount of data can be stored in some fields.

Conventionally, the above mentioned data is stored on a hard disk, a floppy disk, a magnetic disk, a magnetic tape, a CD-RW (CD rewritable), an MO (magneto-optical disk), etc., and accessed as necessary. The data stored in the above mentioned various types of memory units is stored as backup data in other memory units in case of damage to the hard disk, etc.

However, in some fields, there is an enormous amount of data to be stored as described above, and an insurance company is requested to secure the data. In this case, a company for securing data applies a seal on a disk storing the data with the date and the amount of data written on it.

Problem to be Solved by the Invention

However, the following problems occur in the above mentioned conventional system. For example, in the system of storing backup data in other memory units, it is almost impossible to store data in one security company. Especially if a company not specifically related to computers has to pay large cost of computer equipment for storing data. This holds true with a user who has to use, for example, a facsimile device, etc. other than computers.

On the other hand, when an insurance company is requested to secure data, it has to apply a seal to each disk for storing the data. As a result, not a short time is required to appropriately prepare disks and transport them, and the data cannot be stored in real time. Furthermore, in case data is destroyed, a laborious operation is required in reconstructing the data. The present invention has been developed to solve the above mentioned problems, and aims at providing a data security insurance system capable of storing data in a server using a network such as Internet, etc., transmitting the data as necessary, and reconstructing the data when it is destroyed, thereby completely securing the data.

[Means for Solving the Problems]

The above mentioned object can be attained according to claim 1 of the present invention by providing a data security insurance system for connecting a management server of an insurance company to an agent for a contract of insurance of a client having data whose backup data is to be stored through a network; connecting a database center of the insurance company to a terminal device of the client through Internet; transmitting backup data to the database center through Internet when the client contracts the insurance for data security, and storing the backup data in a storage device of the database center; and reconstructing the data of the client using the backup data when the data has been lost.

The agent can be a company relating to, for example, the sales and the production of computers, or to providing various information. However, it is not necessary to contract insurance of data security according to the present invention through the agent. The client is a user requesting data to be stored as backup data regardless of a person or a corporation. The database center receives the data of the client who has contracted the insurance of data security through Internet according to the present invention, and stores the backup data in the storage device. Then, if the data of the client has been lost for any reason, the database center reconstructs the data of the client using the backup data.

Therefore, with the above mentioned configuration, the client who has contracted the insurance of data security according to the present invention can easily and promptly have the data reconstructed.

According to claim 2 based on claim 1 of the present invention, the data has been lost by the invasion of a hacker, a computer virus, or a malfunction.

The reason for the loss of the data is described, for example, on the contract, and practically receives insurance corresponding to the reason for the loss of the data described on the contract.

According to claim 3 based on claim 1 of the present invention, the client contracting the insurance for data security can have the data reconstructed free of charge.

The above mentioned configuration is designed for the benefit of the client.

According to claim 4 based on claim 1 of the present invention, the data is reconstructed using the backup data transmitted by the database center through, for example, Internet. With the above mentioned configuration, the data can be reconstructed soon.

According to claim 5 based on claim 1 of the present invention, the client contracting the insurance for data security can constantly have data backup online with the database center. The above mentioned configuration is designed for the benefit of the client, and for the improvement of security.

The above mentioned object of the present invention can be attained according to claim 6 of the present invention by providing a server device of a data security insurance system, connected to the management server of an insurance company and functioning as a database center. The server device receives data transmitted by a client through Internet when the client contracts insurance for data security, stores backup data in a storage device, transmits the backup data to a terminal device of the client when data of the client has been lost, and reconstructs the lost data.

The present invention relates to a server device of a data security insurance system. With the configuration, a client contracting insurance for data security can easily and promptly reconstruct data.

According to claim 7 based on claim 6 of the present invention, the data has been lost by the invasion of a hacker, a computer virus, a malfunction, or a failure.

According to claim 8 based on claim 6 of the present invention, the client contracting the insurance for data security can have the data reconstructed free of charge.

The above mentioned configuration has been designed for the benefit of the client.

The above mentioned object of the present invention can be attained according to claim 9 of the present invention by providing a server device of a data security insurance system, connected to a management server of an insurance company and functioning as a database center. The server device includes: means for receiving data transmitted by a client through Internet when the client contracts insurance for data security, and storing backup data in a storage device; and means for transmitting the backup data to a terminal device of the client when data of the client has been lost.

With the configuration, a client contracting insurance for data security can easily and promptly reconstruct data. The above mentioned object of the present invention according to claim 10 of the present invention can be attained by providing a computer-readable storage medium storing a program used in a database center connected to a management server of an insurance company, and used to direct a computer to perform the functions of: receiving data transmitted by a client through Internet when the client contracts insurance for data security, and storing backup data in a storage device; and transmitting the backup data to a terminal device of the client when data of the client has been lost, and reconstructing the lost data.

The present invention relates to a storage medium installed in a computer. The storage medium store a program, and can be a floppy disk, CD-ROM, a mini-disk, an optical disk, etc. The present invention can be realized by installing the storage medium in a computer.

With the above mentioned configuration, a client contracting insurance for data security can easily and promptly reconstruct data.

According to claim 11 based on claim 1 of the present invention, the data of the client is stored in a facsimile device. According to claim 12 based on claim 6 of the present invention, data for which the client contracts security insurance is stored in a facsimile device.

According to claim 13 based on claim 9 of the present invention, the data for which the client contracts security insurance is stored in a facsimile device.

With the above mentioned configuration, although the data of the user using a facsimile device has been lost for any reason, the data can be promptly reconstructed using backup data. According to claim 14 based on claim 1 of the present invention, insurance is paid when the data of the client is lost and the data in the database center is also lost.

With the above mentioned configuration, insurance can be paid at the lowest possible probability, thereby reducing the premium of a client.

Furthermore, the data of the client can be lost due to the physical damage of a hard disk. In this case, the physical damage can be caused by fires, convulsions of nature, etc. In these cases, the equipment of the client is normally placed apart from the database center, and there is a small probability that the data on both sides is simultaneously lost. Therefore, there is a small risk that the insurance according to the present invention is paid.

According to claim 15 based on claim 1 of the present invention, insurance is paid when equipment of the client is damaged, a database in the database center is damaged, and the data cannot be restored due to the damage.

According to claim 18 based on claim 1 of the present invention, a model name and a serial number of a unit for storing the data of the client are entered in the database center when the client contracts the insurance, and an amount of backup data of the client in the database center is obtained.

With the configuration, the database center can correctly grasp the backup data and the amount of data, and the data is stored corresponding to the model name and the serial number of the unit for storing the data of the client. Therefore, when the client claims for the insurance for the reason of the destruction of data stored in a different unit, the fact can be correctly confirmed.

The above mentioned object of the present invention can be attained by providing a data security insurance system for connecting a security center of a security company to a client having data whose backup data is to be stored through a first line, and connecting the client to a backup center through a second line; notifying the security center of an abnormal condition of the client through the second line when the first line is unavailable, and notifying the backup center of an abnormal condition of the client through the first line when the second line is unavailable.

With the configuration, an abnormal condition of a hard disk can be correctly detected, thereby guaranteeing the security system of the security company.

Furthermore, according to claim, 21 of the present invention, the security company can also function as the backup center of an insurance company.

### BRIEF DESCRIPTION OF THE DRAWINGS

FIG. 1 shows the configuration of the data security insurance system according to an embodiment of the present invention;

FIG. 2 shows a type of the configuration of the system of a backup center;

FIG. 3 shows the configuration of a practical program of ROM;

FIG. 4 shows the data structure of an external storage device;

FIG. 5 shows the data structure of the link destination based on a link address;

FIG. 6 is a flowchart of the processing operation according to an embodiment of the present invention;

FIG. 7 is a flowchart of the processing operation according to an embodiment of the present invention;

FIG. 8 shows the configuration of the system according to the second embodiment of the present invention;

FIG. 9 is a flowchart of the processing operation according to the second embodiment of the present invention;

FIG. 10 shows the configuration of the system according to the third embodiment of the present invention;

FIG. 11 shows the configuration of the system according to the third embodiment of the present invention; and

FIG. 12 shows the configuration of the system according to the fourth embodiment of the present invention.

### DESCRIPTION OF THE PREFERRED EMBODIMENTS

<First Embodiment>

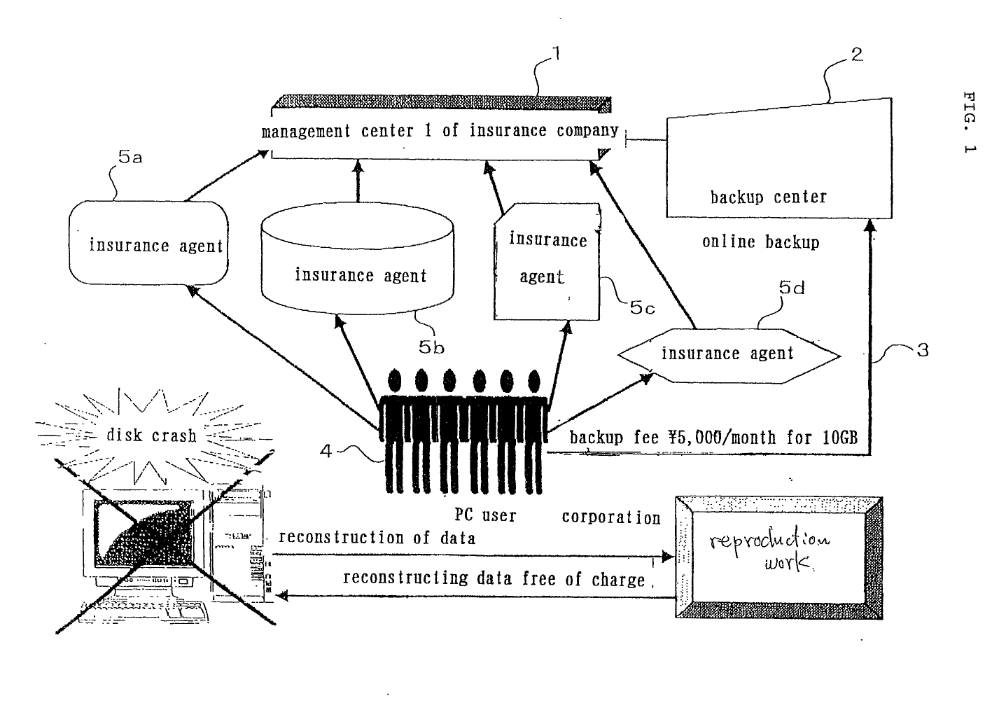

FIG. 1 shows the configuration of the data security insurance system according to an embodiment of the present invention. In FIG. 1, a management center 1 of the present system is mounted in the information management center of an insurance company. A backup center 2 stores various types of data transmitted from a user, that is, a person or a corporation, as backup data. The above mentioned management center 1 is connected to a plurality of insurance agents 5a through 5d through a network line. The network line can be Internet, or a dedicated line. The insurance agents 5a through 5d function between a user and an insurance company, and the user enters a contract of data security with the insurance company through any of the insurance agents 5a through 5d. However, the user can also makes a contract of data security directly with the insurance company. The insurance agent 5a can, for example, sell office automation appliances (0A appliances), and the insurance agent 5b can be a service center of a manufacturer, etc. of personal computers. The insurance agent 5c can be a wholesaler of various information, and the insurance agent 5d can be a mass merchandiser of personal computers. The user normally enters a contract with an insurance company through any of the insurance agents 5a through 5d. For example, when the client buys an 0A appliance including a computer at the insurance agent 5a, the client contracts insurance of data security through the insurance agent 5a. When a user buys a personal computer at a PC mass merchandiser, the user contract insurance of data security through the insurance agent 5d.

The terminal device of a user 4 is mounted in an environment where it can be connected to the backup center 2 through Internet 3. The terminal device of the user is not limited to a personal computer, but can be a mobile telephone or any type of mobile devices.

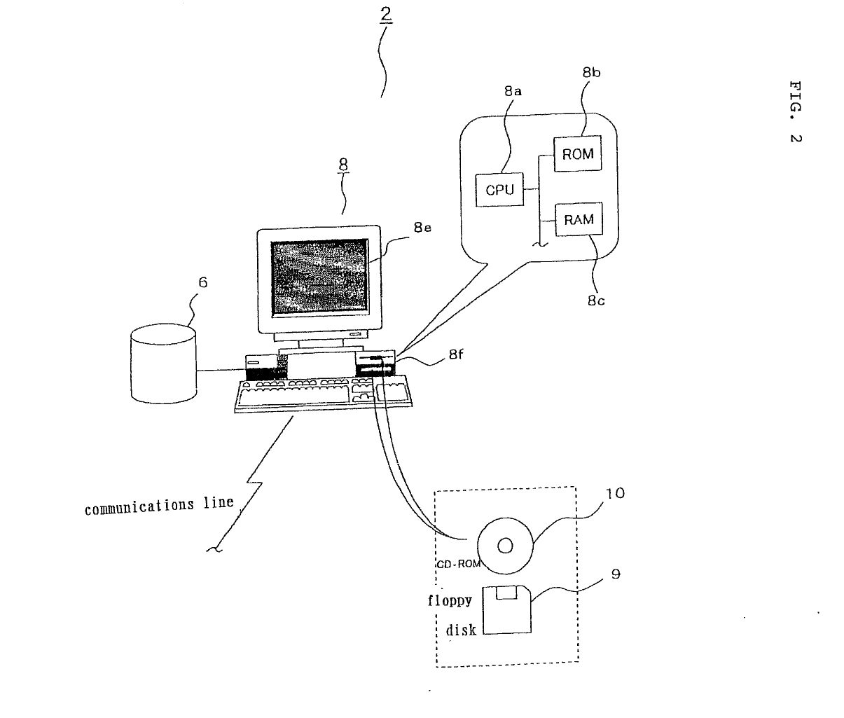

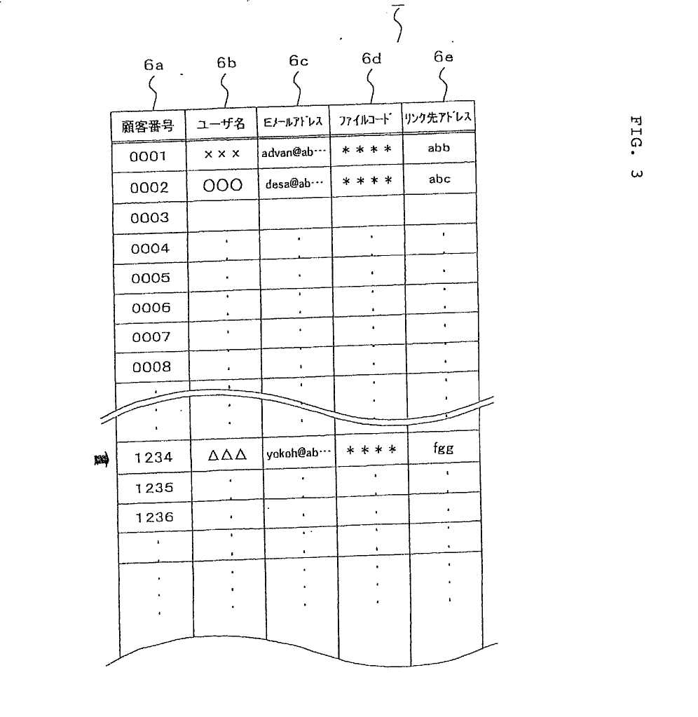

FIG. 2 shows a type of the system configuration of the backup center 2. The backup center 2 comprises a server and a storage device. A server 8 comprises a CPU 8a, ROM 8b, and RAM 8c. The CPU 8a performs a process according to a system program entered in the ROM 8b, writes information described later to an external storage device 6, and reads the information from the external storage device 6. A display 8e displays necessary information, and communicates information through a communications line. A practical program in the above mentioned ROM 8b can be a server application 8b-1, a GUI (graphical user interface) 8b-2, and a Web server 8b-3 as shown in FIG. 3.

The system control according to the present embodiment is performed according to the program stored in the ROM 8b. As shown in FIG. 2, a storage medium such as a floppy disk 9, CD-ROM 10, etc. can be installed in a medium driver 8f mounted on the server 8, and the program can be read and used from the storage medium.

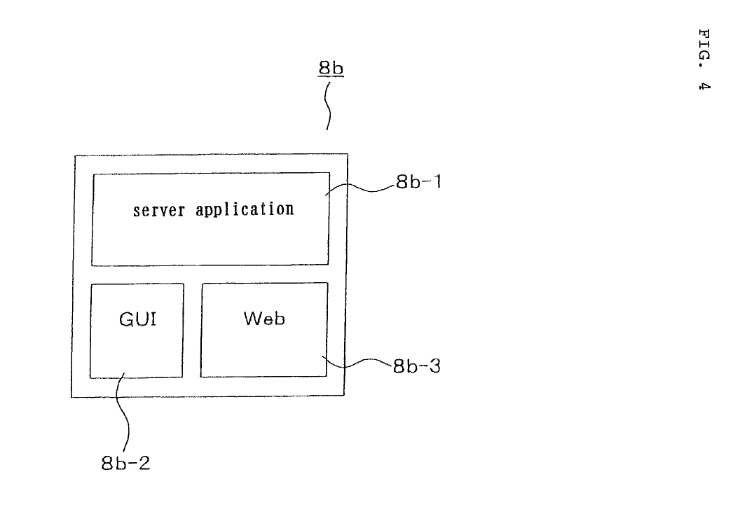

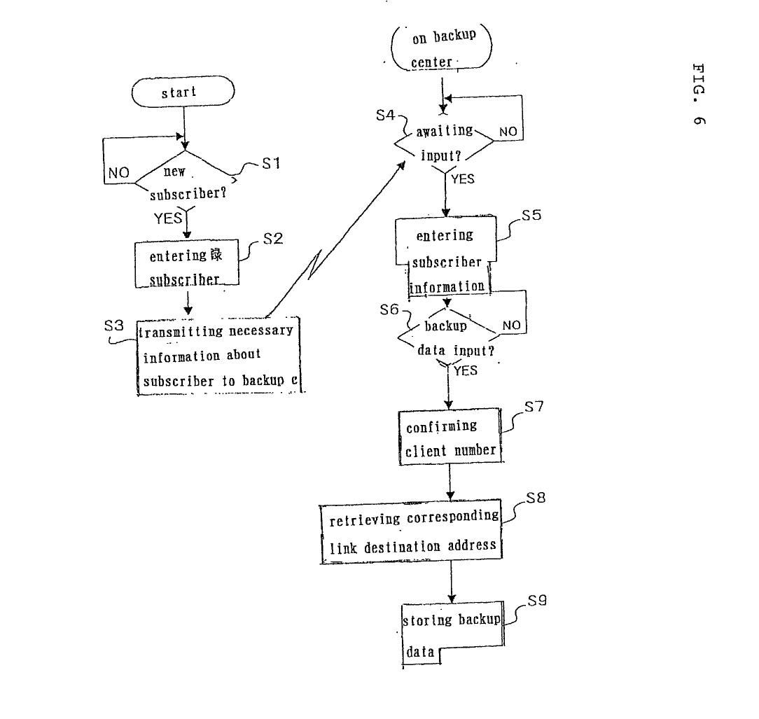

FIG. 4 shows the data structure of the external storage device 6. In FIG. 6, the external storage device 6 stores the data transmitted from the user for backup, and records the user information. For example, as shown in FIG. 4, the user information comprises an area 6a storing the client number of a user, an area 6b storing the name of the user, an area 6c storing the e-mail address of the user, an area 6d storing the file code of the user, and an area 6e storing the link destination address of the actual data. A file code stored in the area 6d indicates the file to be secured by highest priority in the backup data. In the example shown in FIG. 4, corresponding to the client number 0001 in the area 6a, the name ‘xxx’ of a person or a company having the client number 0001 in the area 6a is entered in the area 6b, and the corresponding e-mail address ‘advan@ab . . .’ is entered in the area 61c. Furthermore, the corresponding file code ‘****’ is entered in the area 6d, and the corresponding link address ‘abb’ is stored in the area 6e.

Similarly, corresponding to the client number 0002 in the area 6a, the name ‘ooo’ of a person or a company having the client number 0002 in the area 6a is entered in the area 6b, and the corresponding e-mail address ‘desa@ab . . .’ is entered in the area 6c. Furthermore, the corresponding file code ‘****’ is entered in the area 6d, and the corresponding link address ‘abc’ is stored in the area 6e. Thus, the information about a number of users is stored as shown in FIG. 4.

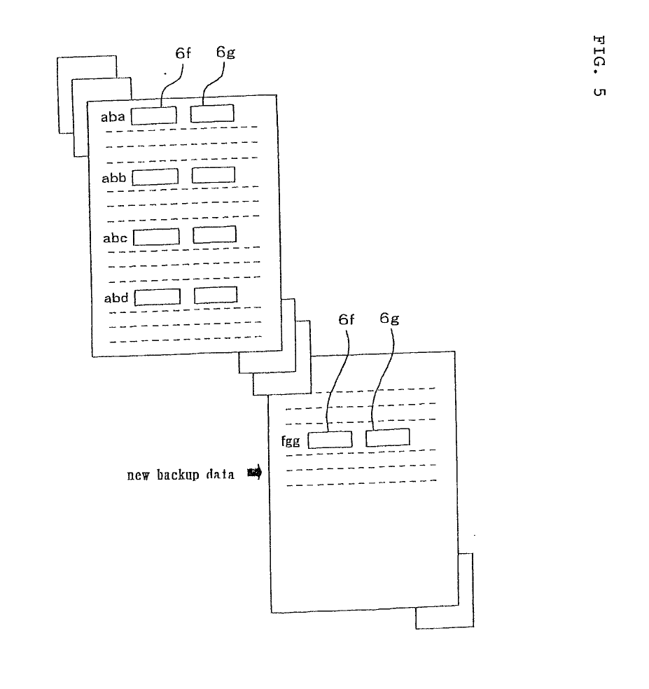

FIG. 5 shows the data structure of the storage area specified by the above mentioned link destination address. The external storage device 6 according to the present embodiment can store various data. When the data comes in various formats, an emulating process is performed to store the data in a plurality of media. Therefore, in the configuration shown in FIG. 2, the external storage device 6 is operated independently, but is shown as a representative of a plurality of media.

In the example shown in FIG. 5, the address area ‘abb’ stores the backup data of the user name ‘xxx’ having the client number ‘0001’. The address area ‘abc’ stores the backup data of the user name ‘ooo’ having the client number ‘0002’. Similarly, the data is stored as shown in FIG. 5.

In each area, a model name 6f and a serial number 6g of the unit of the client having the data are stored with the backup data. With the above mentioned configuration, the operations of the processes according to the present embodiment are described below.

FIG. 6 is a flowchart of the operations of the processes according to the present invention. The processes described below are performed through a network, and the descriptions of the practical operations of preparing and transmitting a contract are omitted here.

In FIG. 6, the management center 1 awaits input of a subscriber contracting insurance of data security according to the present embodiment through the insurance agents 5a through 5d (N in step (hereinafter expressed by S) 1). Then, when there is an application of a subscriber for insurance through any of the insurance agents 5a through 5d (Y in S1), the management center 1 enters the contract of the insurance (S2).

Then, the management center 1 transmits necessary information to the backup center 2 (S3). Upon receipt of the information (Y in S4), the backup center 2 records the data of the new subscriber in the external storage device 6 (S5). For example, when a new user ‘ΔΔΔ’ enters a contract for insurance, the client number, etc. id recorded in the database shown in FIG. 4. For example, the client number ‘1234’ is newly entered in the area 6a, the user name ‘ΔΔΔ’ is entered in the area 6b, the corresponding e-mail address ‘yokoh@ab . . .’ is entered in the area 6c, the file code ‘****’ is entered in the area 6d, and the corresponding link destination address ‘fgg’ is entered in the area 6e as shown in FIG. 4.

Then, the data provided from the terminal device of the user 4 is entered in the backup center 2. In this case, the backup center 2 awaits the data to be provided by the terminal device of the user 4 in the above mentioned status (N in S6). When the data is provided (Y in S6), for example, the client number recorded in the header of the data is confirmed (S7), and then the link destination address of the client is retrieved (S8). Next, the backup center 2 stores the data in the area specified by the link destination address (S9). For example, in the case of the above mentioned user ‘ΔΔΔ’, the link destination address ‘fgg’ corresponding to the client number ‘1234’ is retrieved, and the data is stored in the area at the address ‘fgg’ shown in FIG. 5.

At this time, the model name of 6f and the serial number of 6g of the unit of the client ‘1234’ are also stored. Obviously, the stored model name of 6f and serial number of 6g are those of the unit storing the backup data.

Thus, data is sequentially stored similarly with clients contracting insurance of data security according to the present embodiment.

In the above mentioned process, the data of the client who has contracted insurance of data security is stored in the backup center 2 as backup data.

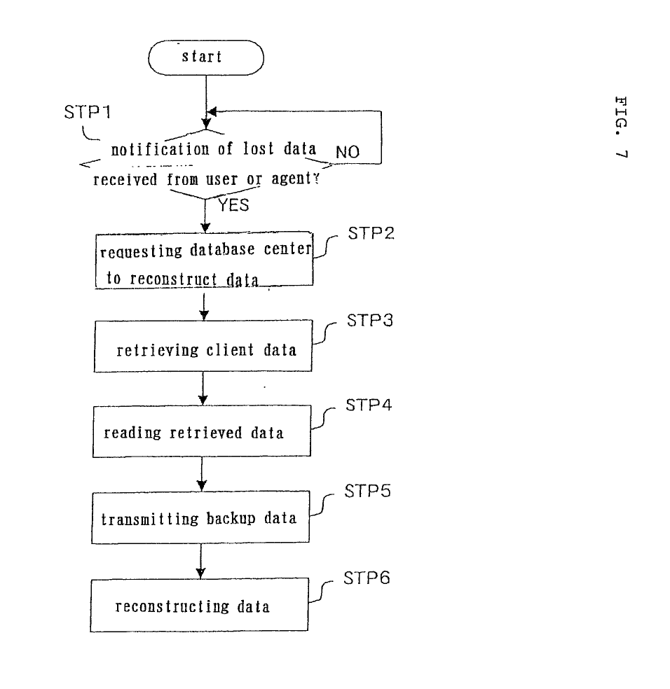

In case a hacker invades the computer of a client who has contracted the insurance of data security, the data has been destroyed by a computer virus, or the data has been lost by an abnormal run of a program, a malfunction, physical damage, etc., the following process is performed. That is, in the above mentioned cases, the client contracting insurance data security can receive a data reconstruction service free of charge. FIG. 7 is a flowchart of the above mentioned data reconstructing process. When the management center 1 first receives a notification that the user has lost his or her data (Y in step (hereinafter expressed by STP) 1), the management center 1 requests the backup center 2 to reconstruct the data (STP 2).

At this time, the client number, etc. is transmitted. Then, the backup center 2 searches for the data to be returned to the client from the client number (STP 3). For example, if the client who has lost the data is ‘xxx’, the data stored at the link destination address is read (STP 4).

Next, the backup center 2 transmits data to the client who has issued the request through Internet 3 (STP 5). The client inputs the data through the terminal device, stores it on a hard disk, etc., and reconstructs the data (STP 6).

As described above, the client contracting the insurance of data security can easily reconstruct data. In addition, since data is transmitted from the backup center 2, the data can be reconstructed soon.

Described below is the comparison between the data security insurance according to the present embodiment and the conventional insurance. It is assumed that 10 Gbytes of data corresponding to 300 thousand pages of document data in the A4 size paper format has been destroyed.

Conventionally, data is manually re-input for reconstruction. Assuming that 100 pages of data is reconstructed by one person a day, a total number of 3,000 persons are required by the equation of 300,000/100=3,000. Therefore, based on the wage of 10,000 yen per day for a person, a total of 30 million yen is required as the cost of reconstructing the data.

On the other hand, when the data security insurance according to the present embodiment, only a premium has to be paid. For example, assuming that the premium is 5,000 yen for every 10 Gbytes, the premium for 5 years is 300,000 yen as computed by the equation of 5,000×12×5=300,000. Therefore, a user can obtain a large merit from the data security insurance according to the present embodiment, and the data can be reconstructed soon as described above.

Furthermore, according to the present invention, the insurance is paid when the data of the client and the data in the database center have been lost. Therefore, there is the smallest possibility that the insurance has to be paid to the client, and the premium of the client can be considerably reduced. In addition, the data of the client can be lost by physical damage to the hard disk. This can be caused by fires, convulsions of nature, etc. In these cases, the equipment of the client is normally mounted apart from the database center, and there is a very small possibility that the data on both sides can be lost. Therefore, the insurance according to the present system has a small risk of the payment of the insurance.

As described above, by contracting the data security insurance according to the present embodiment, the client can receive a merit of both online backup and security, and can also constantly receive an online backup service, thereby reducing the probability of accident and the insurance premium.

In the explanation above, it is assumed that the premium of the data security insurance according to the present embodiment is 5,000 yen for every 10 Gbytes. However, the premium is not limited to this amount, but can be set to 2,000 yen, 3,000 yen, etc. for every 10 Gbytes.

Furthermore, the condition of setting the insurance premium can be the higher when the larger capacity of the file code ‘****’ is specified in the data whose backup data is required. Additionally, as described above, the model name and the serial number of the unit are entered in the database center when the data of a client is stored, and the amount and contents of data to be stored as backup data can be obtained according to the present embodiment.

With the configuration, the center can correctly grasp the amount and contents of the data stored as backup data, and the model name and the serial number of the unit of the client are stored correspondingly, thereby correctly checking the fact although a client claims for the payment of the insurance of data destroyed in a different unit.

<Second Embodiment>

Described below is the second embodiment of the present invention.

The present embodiment relates to storage of data by facsimile. The data input into facsimile is stores in the backup center through a network. Obviously, the insurance is simultaneously set according to the present embodiment.

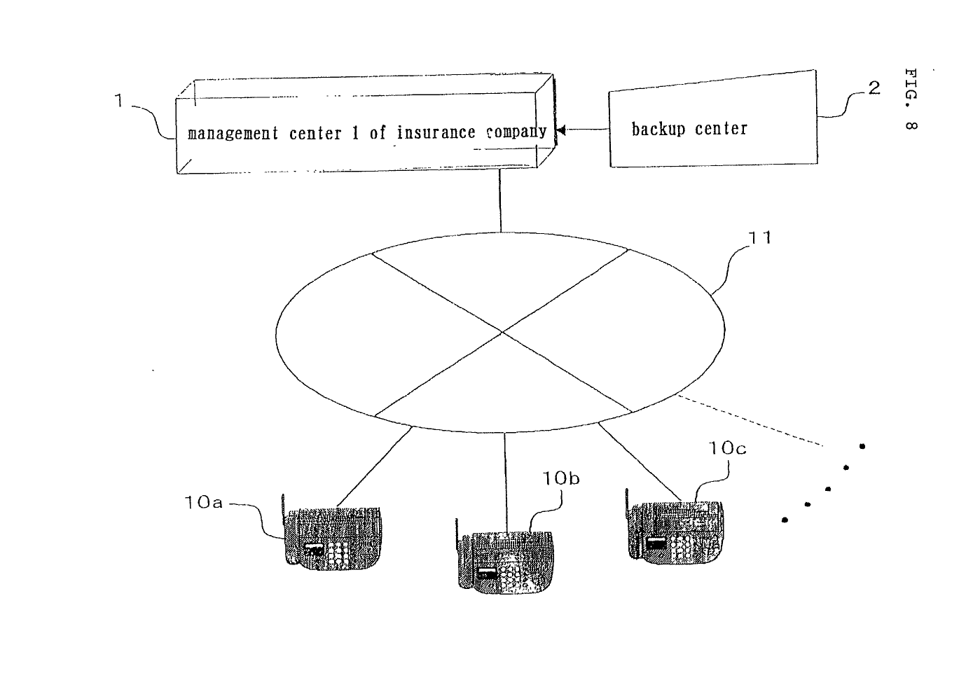

FIG. 8 shows the configuration of the system according to the present embodiment. Basically, the system corresponds to the system shown in FIG. 1 The system shown in FIG. 8 specifically indicates the configuration relating to the present embodiment. In FIG. 8, the management center 1, the backup center 2, facsimile devices 10a, 10b, 10c, . . . of a user (user corporation) are connected through Internet 11. The configurations of the management center 1 and the backup center 2 are the same as those according to the first embodiment. For example, the management center 1 has the system configuration shown in FIG. 2.

The facsimile devices 10a, 10b, 10c, . . . are intelligent facsimiles, and are connected to Internet directly or through an in-house LAN. Furthermore, they are connected to a telephone line not shown in the attached drawings, and communicate document and image data. The facsimile devices 10a, 10b, 10c, . . . includes memory and stores received data as backup data. A user having the facsimile devices 10a, 10b, 10c, . . . with the above mentioned configuration enters a contract of insurance with the management center 1, and have the data which cannot be stored in the memory for backup, or the data which cannot be printed out stored in the backup center 2. The process according to the present embodiment is described below by referring to a flowchart. The entry of a subscriber made between the user and the management center 1 is the same as in the case shown in FIG. 6. That is, a user having the facsimile devices 10a, 10b, 10c, . . . has necessary information stored in the database of the management center 1 in advance.

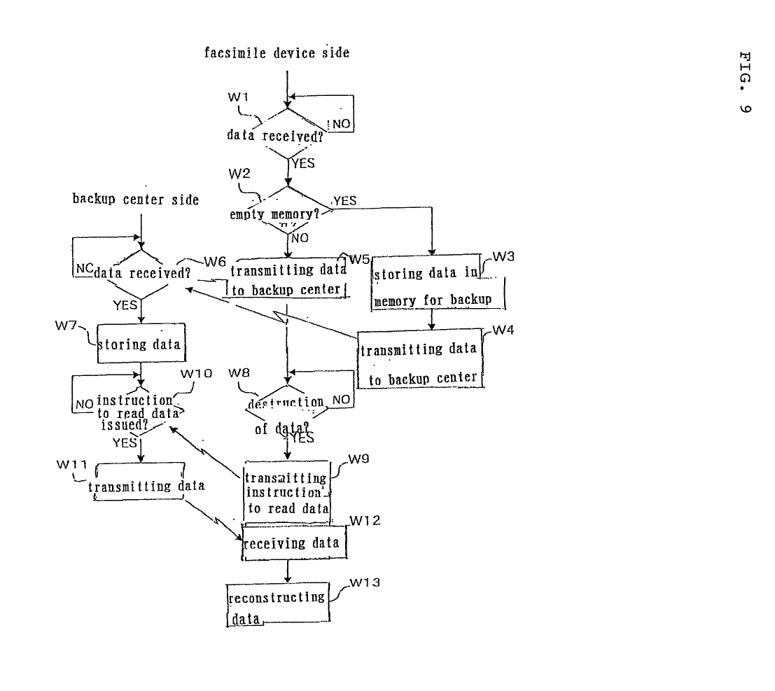

In the flowchart shown in FIG. 9, when data is received by the facsimile device of the user, for example, the facsimile device 10a (YES step (hereinafter expressed by W) 1), it is determined whether or not there is an empty space in the memory (ST 2). If there is an empty space in the memory (YES in ST2), data is stored in the memory as backup data (ST 3). Then, the data stored in the memory as backup data is transmitted to the backup center 2 through Internet 11 (ST 5). On the other hand, if there is no empty space in the memory (NO in ST 2), then the data is immediately transmitted to the backup center 2 through Internet

In the backup center 2, the data is stored in the database (W6 and W7). The data is stored when, for example, the facsimile device 10a is running out of paper, the facsimile device 10a becomes faulty, and for example, cannot print out the data, etc. Thus, if the data in the memory has been destroyed by the invasion of a hacker and the trouble with the facsimile device 10a after the data has been stored for backup, the backup center 2 is instructed to read the data (W9 if YES in W8). The backup center 2 reads the data of the facsimile device 10a at the instruction, and transmits the data (W11 if YES in S10).

The facsimile device 10a reconstructs the lost data using the transmitted data (W12 and W13). Therefore, although the memory of the facsimile device 10a has been destroyed, and the data has been lost, the backup center 2 is insured against the destruction or loss of data, and the backup data is read, thereby reconstructing the data. The reconstruction of the data is performed free of charge in the scope of the insurance. The insurance premium can depend on the amount of backup data, the available facsimile device, or the available environment of the facsimile device.

In the data stored in the backup center 2, only the data stored in the memory is transmitted, and the data not stored in the memory but stored only in the backup center 2 is normally transmitted to the facsimile device 10a as necessary. The insurance premium can depend on the capacity of the memory, and the ratio of the backup data stored in the memory of the facsimile device to the normal backup data.

In the explanation above, the facsimile device 10a is described, but other facsimile devices 10b, 10c, can be similarly operated.

<Third Embodiment>

Described below is the third embodiment of the present invention.

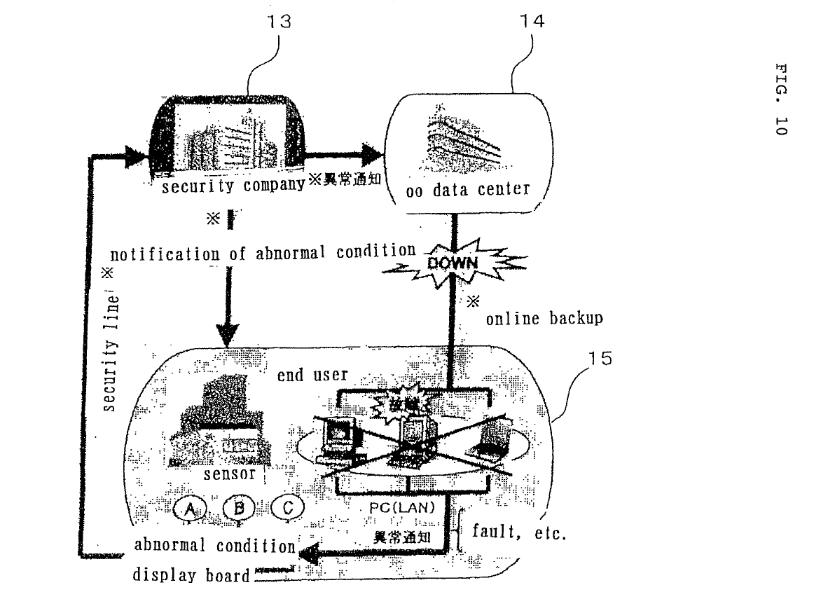

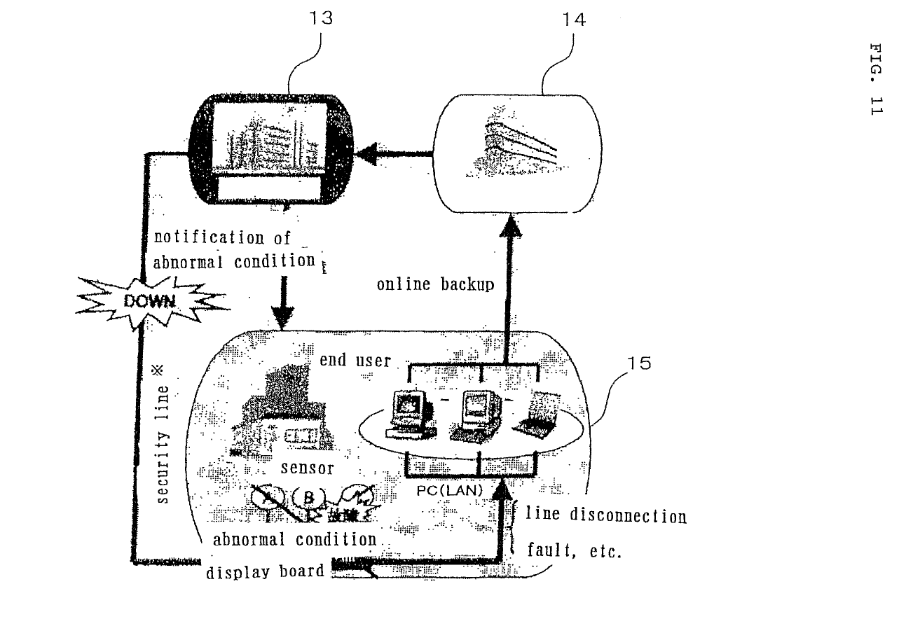

In the above mentioned example, no security company is involved in the data security insurance system, but the present embodiment includes a system in which a security company secures the data on the hard disk of a client and protects the house and the office storing the data against fires, burglaries, etc. FIGS. 10 and 11 show the present system. FIG. 10 shows an example of detecting an abnormal condition on the online backup side, and FIG. 11 shows an example of detecting an abnormal condition on the security system side. First, in FIG. 10, a security company 13, a oo data center 14, and an end user 15 are connected through a public line, an ADSL (asymmetric digital subscriber line), an optical fiber cable, a cable TV (CATV), an ISDN line, etc. For example, when the security line shown in FIG. 10 is connected through the public line, the line for online backup is connected through, for example, a cable TV line. The security line can be connected through the ISDN line, and the online backup line can be connected through another line. Furthermore, the end user 15 requests the security company 13 to secure the data against fires, burglaries, etc., and further requests the oo data center 14 to store online backup data. Therefore, a plurality of sensors A through C are mounted in the house or the office of the end user 15 so that an abnormal condition detection signal can be transmitted to the security company 13 through the above mentioned security line when, for example, smoke is detected, an abnormal unlocking operation is detected, etc. Furthermore, the data stored on a hard disk of a personal computer, etc. is stored for backup in the oo data center 14 through an online backup line.

With the above mentioned configuration, when an abnormal condition occurs on the hard disk of the end user 15 and the online backup function goes down, the abnormal condition is displayed on the abnormal condition display board. The cause of an abnormal condition or a fault can be a wrong use of a hard disk, a fault of the appliance loaded with a hard disk of a personal computer, etc.

Upon receipt of a notification of the above mentioned abnormal condition, the abnormal condition display board notifies the security company 13 of the abnormal condition information about the hard disk through a security line. Upon receipt of the notification, the security company 13 notifies the oo data center 14 and also the end user 15 of the fact through electronic mail or telephone.

With the configuration, although the hard disk of the client has been destroyed, the oo data center 14 can be notified of the fact, immediately disconnects the line, thereby preventing the erroneous data from being recorded and successfully securing the data.

On the other hand, when the security line side goes down, the system shown in FIG. 11 functions. In this case, an abnormal condition signal is output from the abnormal condition display board, and an abnormal condition detection signal is output to the oo data center 14 through the LAN to which a personal computer, etc. is connected. At this time, abnormal condition information is output to the oo data center 14 through the online backup line according to the present embodiment. The oo data center 14 notifies the security company 13 of the information through electronic mail or telephone. Upon receipt of the notification, the security company 13 is informed that the security line has gone down, sends a security staff to the end user 15, and notifies the end user 15 of the information using a mobile phone, etc.

As described above, the end user 15 uses the security line with the security company 13, and also uses the online backup line. Therefore, although one line has gone down, the end user 15 can be informed of an abnormal condition through the other line, thereby obtaining an effective security system. Using the system, the data security insurance premium can be amended. As a result, it is also an effective system for the security company 13.

In the description above, the security company 13 and the oo data center 14 has different configurations, but a security company can also functions as a backup center.

<Fourth Embodiment>

Described below is the fourth embodiment of the present invention.

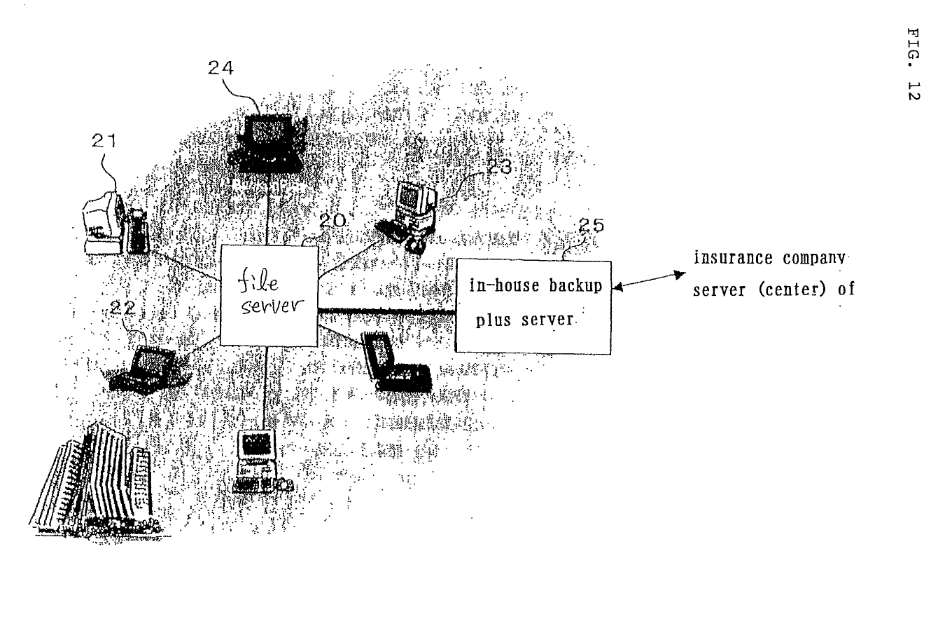

In the present embodiment, the entire configuration is included, for example, in a company. In FIG. 12, the system connects each departments through a file server 20. For example, a personal computer 21 of the personnel department, a notebook 22 of the designing department, a personal computer 23 of the sales department, a notebook 24 of the president's office, etc. are connected to the file server 20.

Furthermore, the file server 20 is connected to a server 25 of the backup plus according to the present embodiment. The server 25 inputs the data of each department through the file server 20, and stores the data in the database not shown in FIG. 12. The server 25 is connected to the center of the insurance company not shown in FIG. 12, and communicates the management information, maintenance information, etc. about backup data. With the above mentioned configuration, the data can be stored for backup by the backup server provided in the company without disclosing the in-house information, thereby successfully storing data for backup as in the case of a backup server provided in a insurance company.

Since it is connected to a server of an insurance company, the maintenance and management of a backup server can be performed by a server of the insurance company, thereby guaranteeing the security and backup of data.

Effect of the Invention

As described above, according to the present invention, data can be easily reconstructed although an unexpected disk fault has occurred.

The data security insurance according to the present invention can not only reconstruct data free of charge when an accident occurs, but also can receive a constant online backup service by combining the data security with the online backup. Therefore, the integrity of data can be improved.

Furthermore, the payment of insurance is made when the data of the client has been lost and simultaneously when the data of the database center has been lost. That is, there is the smallest possibility that the insurance is paid. As a result, the insurance premium of the client can be reduced.

In addition, when data of a client is stored, the model name and the serial number of a user unit are entered in the database center, and the amount and contents of the data of the client stored in the database center for backup can be obtained. Thus, the center can correctly grasp the amount and the contents of the data. In addition, the model name and the serial number of the unit of the client are also stored corresponding to the data so that the fact can be correctly checked when the client claims for the payment of insurance for the reason of the destruction of data stored in a different unit of the client.

Furthermore, a facsimile device can be insured, and backup data is stored for the reconstruction of the data free of charge in case of an accident, etc.

In addition to the security against burglaries, fires, etc. guaranteed by a security company, a more effective security system can be obtained using an online backup line.

What is claimed is:

1. a data security insurance system, comprising:
connecting a management server of an insurance company to an agent for a contract of insurance of a client having data whose backup data is to be stored through a network;
connecting a database center of the insurance company to a terminal device of the client through Internet;
transmitting backup data to the database center through Internet when the client contracts the insurance for data security, and storing the backup data in a storage device of the database center; and
reconstructing data of the client using the backup data when the data has been lost.

2. The system according to claim 1, wherein said data has been lost by invasion of a hacker, a computer virus, a malfunction, or a failure.

3. The system according to claim 1, wherein said client contracting the insurance for data security can have the data reconstructed free of charge.

4. The system according to claim 1, wherein said data is reconstructed using the backup data transmitted by the database center through Internet.

5. The system according to claim 1, wherein said client contracting the insurance for data security can constantly have data backup online with the database center.

6. A server device of a data security insurance system, connected to a management server of an insurance company and functioning as a database center, comprising:
receiving data transmitted by a client through Internet when the client contracts insurance for data security, and storing backup data in a storage device; and
transmitting the backup data to a terminal device of the client when data of the client has been lost, and reconstructing the lost data.

7. The server device of the system according to claim 6, wherein
said data has been lost by invasion of a hacker, a computer virus, a malfunction, or a failure.

8. The server device of the system according to claim 6, wherein
said client contracting the insurance for data security can have the data reconstructed free of charge.

9. A server device of a data security insurance system, connected to a management server of an insurance company and functioning as a database center, comprising:
means for receiving data transmitted by a client through Internet when the client contracts insurance for data security, and storing backup data in a storage device; and
means for transmitting the backup data to a terminal device of the client when data of the client has been lost.

10. A computer-readable storage medium storing a program used in a database center connected to a management server of an insurance company, and used to direct a computer to perform the functions of:
receiving data transmitted by a client through Internet when the client contracts insurance for data security, and storing backup data in a storage device; and
transmitting the backup data to a terminal device of the client when data of the client has been lost, and reconstructing the lost data.

11. The system according to claim 1, wherein said data of the client is stored in a facsimile device.

12. The server device of the system according to claim 6, wherein
data f or which the client contracts security insurance is stored in a facsimile device.

13. The server device of the system according to claim 9, wherein
data for which the client contracts security insurance is stored in a facsimile device.

14. The system according to claim 1, wherein insurance is paid when the data of the client is lost and the data in the database center is also lost.

15. The system according to claim 1, wherein insurance is paid when equipment of the client is damaged, a database in the database center is damaged, and the data cannot be restored due to the damage.

16. A server device of the system according to claim 6, wherein
insurance is paid when the data of the client is lost and the data in the database center is also lost.

17. The server device of the system according to claim 6, wherein
insurance is paid when equipment of the client is damaged, a database in the database center is damaged, and the data cannot be restored due to the damage.

18. The system according to claim 1, comprising entering a model name and a serial number of a unit for storing the data of the client in the database center when the client contracts the insurance, and obtaining an amount of backup data of the client in the database center.

19. The server device of the system according to claim 6, comprising
entering a model name and a serial number of a unit for storing the data of the client in the database center when the client contracts the insurance, and obtaining an amount of backup data of the client in the database center.

20. A data security insurance system, comprising: connecting a security center of a security company to a client having data whose backup data is to be stored through a first line, and connecting the client to a backup center through a second line;
notifying the security center of an abnormal condition of the client through the second line when the first line is unavailable, and notifying the backup center of an abnormal condition of the client through the first line when the second line is unavailable.

21. The system according to claim 20, wherein said security company functions also as the backup center.
